(19) United States
(12) Patent Application Publication
(10) Pub. No.: US 2010/0288877 A1
(43) Pub. Date: Nov. 18, 2010

(54) DECOY PROTECTION SYSTEM FOR AIRCRAFT AND METHOD OF PROTECTION

(76) Inventor: Joseph L. Strabala, Orinda, CA (US)

Correspondence Address: JOSEPH L. STRABALA, ESQ., ONE EMBARCADERO CENTER, SUITE 1020, SAN FRANCISCO, CA, 94111, US

(21) Appl. No.: 11/946,210

(22) Filed: Nov. 28, 2007

(51) Int. Cl. B64D 45/00; F23C 99/00

(52) U.S. Cl. 244/1 TD; 431/8

(57) ABSTRACT

The current invention is inclusive of a decoy protection system and method of protecting jet aircraft from shoulder fired missiles comprising while such aircraft is in a flight envelope where it is susceptible to being hit by a such a missile, by employing a decoy means towed by aircraft at a distance away from the aircraft whereby the decoy means is located sufficiently remote away from any part of said aircraft that a missile strike on the decoy mean will not normally damage the aircraft, supplying said decoy means with jet fuel from said aircraft and burning said jet fuel in the decoy means to create a high intensity IR signature in the decoy means sufficient to divert shoulder fired missiles from said aircraft to said decoy means.

Burning jet fuel in such a decoy means, such as a pulse jet engine configuration for the decoy, creates IR and UV signatures at the decoy means that are nearly identical to those of the jet engines of a aircraft protected by the system and method; further it creates an exhaust plume from the decoy means that is very similar in spectra to the exhaust plumes of the aircraft's engines to fool discriminators used in some of such missiles.

### BACKGROUND

This invention relates to an anti-missile defense system and more particularly, a missile diverting decoy for commercial and other large jet aircraft.

Concern exists today that terrorists, with shoulder fired missiles, will shoot down commercial and/or military aircraft approaching and departing airfields. A shoulder-fired missile, often called MANPADS, for Man Portable Air Defense Systems, can be bought on the black market for as little as a few thousand dollars, and slipped into a golf bag for transport to a launch area.

The most common shoulder filed missile is the Russian SA-7 which was introduced in 1969 during the Egyptian-Israeli War of Attrition and is of great concern. The FBI estimates that from 1978 through 1998, 29 civilian planes were downed by shoulder fired missiles, including the SA-7, most of them in war zones. A total of 550 people died.

The relatively simple design and low cost of the SA-7 missile has led to its wide distribution among guerrilla groups, as the cost of an SA-7 is as low as $5,000. It is estimated that in the last 15 years, more than 50,000 shoulder fired missiles systems, mostly SA-7s, have been sold to Third World countries. At least 17 terrorist organizations, and 56 countries are believed to possess shoulder fired SA-7 missiles.

At low altitudes current jet aircraft are particularly vulnerable to attack from IR-guided surface-to-air from shoulder fired missiles which use infra-red [IR] target acquisition systems. Statistical data of aircraft losses in hostile actions since 1980 show that the majority of losses have been the result of use of IR-guided missiles.

These missiles, and similar missiles, prose a real threat during aircraft landings and take offs at airports, as the SA-7 can reach altitudes of up to 9,000 feet, and can be launched up to two miles from the target.

High -priced onboard anti-missile systems can sometimes detect heat-seeking missiles and then send out high-temperature flares to divert the missile away from the plane. A flare goes through three main stages: ignition, deployment, and decoying. Most flares, like the MJU-27A/B flares, must be kept in an airtight storage compartment before deployment. These flares, known as pyrophoric flares, are made of special materials that ignite when they come in contact with the air. This is a safety and convenience factor, since attempting to ignite a flare inside of the fuselage and then deploying it is risky. However pyrotechnic flares (such as the MJU-32) also exist, and offer their own safety benefit; requiring an external ignition method whereby an accidental leak or puncture in the storage compartment would not result in a catastrophic fire onboard in an aircraft, as with a pyrophoric flare. The newest generation of the FIM-92 Stinger uses a dual IR and UV seeker head, which allows for a redundant tracking solution, effectively negating the effectiveness of modern decoy flares (according to the U.S. Department of Defense). While research and development in flare technology has produced an IR signature on the same wavelength as hot jet engine exhaust, modern flares still produce a notably (and immutably) different UV signature than an aircraft engine burning kerosene jet-fuel. The instant invention produces both signatures, IR and UV matching a jet engine, by burning jet fuel in its decoy.

Experts estimate these anti-missile flares are about 90 percent effective when timely deployed against older shoulder filed missiles, but flares cannot be indiscriminately dropped over populated areas and are of no use if the missile is not detected before deployment of the flares. Further such flares have a limited burn life. If the flares burn out too quickly they may not be effective and if the burn life is extended such flares pose a risk to people on the ground as long burning flares pose a fire hazard to combustibles on the ground, wherefore they are risky for use in urban areas,” according to the Congressional Research Service report. Further, newer missiles can as the saying goes, tell the difference between a falling brick (a released flare) and a flying aircraft. Considerable effort has been expended in developing flares that closely mimic the IR signatures of jet aircraft engines to improve the effectiveness of flares. In addition self propelled flares have been developed.

Another defense is active destruction using anti-missiles to shoot down incoming guided missiles, but this provides, at best, only partial protection especially during take off and landings. Any such an anti-missile system must first acquire an incoming missile as a target and then, after detection, launch a counter missile. At low altitudes detection is problematic due to ground return received by the detection system. Obviously launching multiple missiles about populated airports is less than prudent.

In development is an anti-missile system, which detects the rocket plume from a incoming missile and aims a laser beam at the missile's sensors to blind its sensors. Use of such lasers systems against heat-seeking missiles are often unreliable as such system are prone to frequent breakdowns and have high maintenance costs.

Defense contractor Northrop Grumman, which makes jammers for military aircraft, has submitted a proposal to the Homeland Security Department as part of the two-year review. Company officials say it would cost $1 million to $2 million per plane to install such jammers. On a commercial jet, jammers are proposed to be installed in a canoe-shaped pod under the plane measuring 5 feet long, 18 inches wide and a foot deep. However cost estimates, which don't include maintenance costs, could run as high as $10 billion a year for the domestic fleet of 5,500 commercial aircraft.

IR jammers have not been particularly successful for a number of reasons. The lamp sources of IR energy have difficulty generating sufficient intensity to overcome the aircraft engine's IR signature. Also they are required to be omni-directional to counter a missile attack from any direction which dilutes their energy density to a point that such jammers may become partially ineffective.

Since different types of IR-guided missiles rarely use the same signal processing technology, it has not been possible to create a generic jamming modulation effective against all missiles. This can only be accomplished if the jammer designer has intimate knowledge of the missile IR seekers which allows him/her to exploit its design vulnerabilities.

Fortunately shoulder fired missiles have a limited “burst radius or kill radius” [about 8 meters] due to their limited explosive charge, thus a decoy or flare need not be too far away from an aircraft to provide a safe guard while the aircraft is in a threat envelop. Placing reliance on the limited “kill raduis” U.S. Pat. No. 6,267,039 assigned to the Department of Defense, teaches creating hot IR signature a part of an aircraft which is less venerable catastrophic failure if a missile strike occurs on such parts. An example prior-art operational vulnerability reduction system is the sacrificial engine-nozzle extension applied several years ago to Israeli A-4 aircraft, so IR-seeking missiles attracted to this hot-spot location destroy only the sacrificial extension. Problems with this approach is that missile from aft of the aircraft often hit the engine proper and the added weight lowers aircraft range. While experts point out that modern jets are built to withstand the loss of an engine in flight, the vulnerability of commercial aircraft to shoulder fired missile attacks is still under assessment.

Some data indicates that not all missile strikes are catastrophic and the strikes are largely from the rear of an aircraft. Of the five previous attacks on large turbojet airliners, two resulted in crashes that killed everyone onboard, two caused significant damage to the aircraft but no fatalities, and one missed the plane.

U.S. Pat. No. 6,683,555 issued to Carlson et al teaches a very complex system for fast deployment and retrieval of a electronic decoy system in response to a detected incoming threat, thereby eliminating the necessity of pre-deployment of the decoy. However, such systems are used in situations where there is a ground separation of the aircraft of at least 10,000 feet and are generally for use outside the range of shoulder fired missiles. The Carlson device depends on diverting an incoming missile while it is under radar guidance and before it can use an infrared [IR] guidance to lock on a heat generating portions of an aircraft target. However such systems are not effective against a missile relying solely on IR tracking, such as shoulder filed missiles or for aircraft at lower altitudes. Similar devices are the ALE-50, the more modern ALE-55, Towed Decoy systems currently in the inventory of the US Armed Forces which are typically expendable towed vehicles, i.e., dropped after deployment in a threat zone and after the aircraft has left such a zone.

There are a number of US patents that, in general cover towed decoy deployment systems, such as U.S. Pat. Nos. 5,603,470; 5,605,306; 5,570,854; 5,501,411; 5,333,814; 5,094,405; 5,102,063; 5,136,295; 4,808,999; 4,978,086; 5,029,773, 5,020,742; 3,987,746 and 5,014,997, all incorporated by reference herein by way of background. Other patents of interest are U.S. Pat. No. 3,339,201 issued to Fischer et al.; U.S. Pat. No. 3,987,746 issued to McCulloh; U.S. Pat. No. 4,808,999 issued to Toman; U.S. Pat. No. 4,978,086 issued to Spicer; U.S. Pat. No. 5,014,997 issued to Smith et al; U.S. Pat. No. 5,020,742 issued to Haslim; U.S. Pat. No. 5,029,773 issued to Lecat; U.S. Pat. No. 5,094,405 issued to Brum; U.S. Pat. No. 5,102,063 issued to Brum; U.S. Pat. No. 5,136,295 issued to Bull et al; U.S. Pat. No. 5,260,820 issued to Bull et al; U.S. Pat. No. 5,333,814 issued to Wallis; U.S. Pat. No. 5,398,032 issued to Tucker et al; U.S. Pat. No. 5,497,156 issued to Bushman; U.S. Pat. No. 5,501,411 issued to Brum et al; U.S. Pat. No. 5,570,854 issued to Brum et al; U.S. Pat. No. 5,603,470 issued to Fitzgerald et al; U.S. Pat. No. 5,605,306 issued to Fitzgerald et al; U.S. Pat. No. 5,836,535 issued to Brum.

The number of patents referenced indicates the need to provide a low cost, highly effective protection system for jet aircraft against shoulder fired missiles.

This invention provides an effective method and decoy for diverting IR guided missiles which permits deployment of the decoy during the critical approach and departure periods of aircraft at airfields and which also allows the decoy to be retrieved when the aircraft is outside of the threat envelop so that it can be redeployed.

This invention also provides a decoy with a heat signature significantly greater than aircraft's engines IR signature as a counter measure since IR guidance systems of shoulder fired missiles typically lock on to the hottest heat (IR) source scanned by its IR guidance system. This is the reason such missiles typically home in on the engines of the aircraft or in the alternative, defensive flares when such flare as deployed.

An object of this invention is to provide an effective decoy with a heat signature significantly greater than the IR signature of any part of the aircraft which is the target and which is deployed remote from the aircraft proper, that is at a location outside of a shoulder fired missile's kill radius releative to an aircraft employing such a system.

A further object is to provide a heat signature in a decoy which is substantially similar to that produced by the engines of a jet aircraft in both the IR and UV radiation profiles of the exhaust plume.

It is also an object to provide a decoy assembly which is simple and easy to control, as well as light weight.

In addition it is an object to provide a decoy that is economical and is not dependant on complex electronic systems to sense a threat of an incoming missile before deployment.

Another object of this invention is to create a missile strike zone with a significantly high IR signature, sufficiently remote from the aircraft that the aircraft will avoid catastrophic damage from the explosion of a shoulder fired missile impacting the decoy.

According to this invention it is an object to provide decoy assembly that addresses the above problems which can be pod-mounted in the rear, under belly, or on a wing of the aircraft or which can be deployed on a boom or a hose tether arrangement.

Other objects and advantages will be apparent from the specification and the drawings accompanying it.

### SUMMARY OF THE INVENTION

The current invention accomplishes the forgoing objectives, and others, by a decoy which is deployed from an aircraft on a tether or boom capable of suppling jet fuel from the aircraft to the decoy, and creating a thermal signature in the decoy by burning the jet fuel in the decoy whenever an aircraft using the decoy in a threat envelop. It includes a method of protecting aircraft by burning jet fuel from a aircraft in a decoy remote from the protected aircraft to create a high intensity thermal signature a significant distance away from the aircraft so the aircraft is outside the burst radius of most hand shoulder fired missiles impacting the decoy.

A simple reel system for a flexible tether can be used for deploying decoy before the aircraft enters the threat envelop and to retrieve it after the aircraft has departed the threat envelop. The tether, in addition to supplying jet to the decoy, also provides the controls to turn on and off the decoy's torching system which burns the jet fuel supplied to it form the aircraft.

In addition to a flexible tether for the decoy, the instant invention contemplates mounting the decoy on a rigid boom which is extended from the underside of an aircraft equipped with the system when it is in use and retrieved in a telescoping manner when not in use.

### BRIEF DESCRIPTION OF THE DRAWINGS

FIG. 1 is schematic of a pulse jet illustrating its various components;

FIG. 2 is a top view of a large aircraft equipped with pods on its mid-section for incorporation the decoy protection system of this invention on such an aircraft;

FIG. 3 is an elevation of a smaller aircraft, than shown in FIG. 3, which has decoy protection system deployed on a tailing tether in a pod locate at the rear of the aircraft;

FIG. 4 is an elevation of a jet aircraft with the decoy protection system deployable on a boom with the boom shown in a retracted position;

FIG. 5 is the same elevation of the jet aircraft shown in FIG. 4 with boom deployed; and

FIG. 6 is a perspective of a pod for decoy protection system that can be mounted on an aircraft at various locations, such as the wings, fuselage, pylons or the underbelly of an aircraft employing the system.

### DESCRIPTION OF AN EMBODIMENT

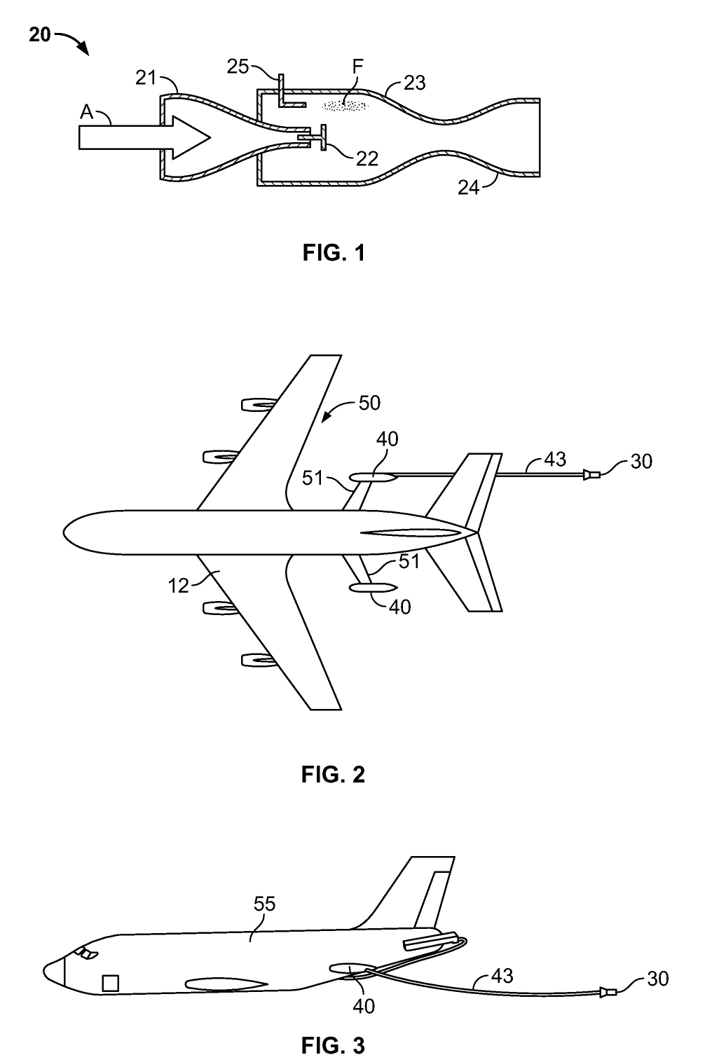

At the heart of the invention, is a jet engine fuel (kerosene) burning decoy which can be an air driven torching system or a pulse jet engine, such as shown in FIG. 1. Referring to FIG. 1, the schematic shows a pulse jet 20 having an air inlet 21, with a flapper valve 22 and combustion chamber 23 that is connected to a tail pipe 24. A large arrow A indicates incoming air that will typically be supplied by the airstream from the aircraft's movement, which is usually above 100 knots when the decoy is deployed. Fuel nozzle 25 injects jet fuel F into the combustion chamber where it mixes with the incoming air and an igniter (not shown) causes the mixture of air and jet fuel to combust. The resulting increase in pressure in the combustion chamber closes the flapper valve and expels the combustion products through the tail pipe subsequently causing a drop in pressure in the combustion chamber, thereby allowing for forgoing cycle to repeat.

In a commercial pulse jet design, a grating is placed just behind the air intake which has a plurality of spring loaded flapper valves. Adjacent to the flapper valves are fuel nozzles aimed into the combustion chamber and a glow plug is mounted in the combustion chamber. As a result the incoming air, mixed with the fuel explodes and creates a pressure in the combustion chamber that closes the flapper valves. The explosion is followed by a momentary drop in pressure in the combustion chamber allowing flapper valves to open to admit a new charge of air. The forgoing process is known as pulse.

Frequencies of the pulses in such a device can be as large as 2,400/minute but lower for larger devices. For a pulse jet to work the combustion chamber and the tail pipe is tuned to the natural frequency of the flapper valves, which is why a pulse jet is some times called a resonance jet. This type of jet engine is fuel greedy and runs extremely hot, with the tail pipes glowing white from the heat.

Leaving the combustion chamber and tail pipe of the decoy unshielded a significant and high intensity IR signature is created as these parts are heated to the range of 1200 degrees F. (650 degrees C. and 922 degrees K) and higher during the operation of such a pulse jet. Moreover since the IR and UV signatures obtained by burning jet fuel will be the same as the exhaust plumes of the jet engines of the aircraft on which the protection system is deployed. Typically the IR profile of the engines of a jet aircraft have an exhaust plume of 320 degrees Kelvin due to the cowling enclosing the combustion chamber and air flow over the engines, according to Feasibility Studies of Infrared Aircraft Exhaust Measurement [http:// www.op.dir.de/oe/ir/b747.hml]. Thus it is possible to develop an IR and UV signatures with the novel decoy system that exceed those of the engines of jet aircraft protected by the system, excepting afterburner operations. According to Boltzmann's Law, the emissivity of a surface is proportional to the fourth power of its absolute temperature whereby the higher absolute temperature of the decoy will attract such missiles.

Since a pulse jet engine develops thrust, a partial clam shell can paced behind the tail pipe of the engine which reverses part of the thrust so that the engine will not produce a positive thrust when it is used as a decoy on a flexible tether. However, when the decoy is deployed on a boom extending telescopically from the belly of an aircraft the thrust can augment that of the engines of the aircraft.

The forgoing torching means (described as pulse jet) is merely illustrative of one such means that can be used in the novel protection system and is hereinafter designated as decoy 30.

By deploying the novel decoy 30 by towing it on a tether, or extending it from an aircraft on a boom, insures that it will be kinematically correct (flying the same profile as the aircraft and within the field of view of the missile's IR seeker) when a missile aimed at an aircraft deploying the protection system. This is important because some missiles discriminate between a falling decoy and a flying aircraft. Also import is the fact that the decoy of this invention burns jet fuel from the aircraft so that is matches the burn profile of hydrocarbon based jet fuels from aircraft's jet engine or engines. Moreover the decoy emits a plume that spectrally matches that of its host aircraft's jet engines which effectively defeats any temporal discriminants used in some IR-guided missiles. Since the decoy of this invention burns jet fuel supplied from the aircraft its heat signature can be sustained for an extended periods of time without difficulty, such as a missed landings approach, or the like, where the decoy is deployed for an extended period of time.

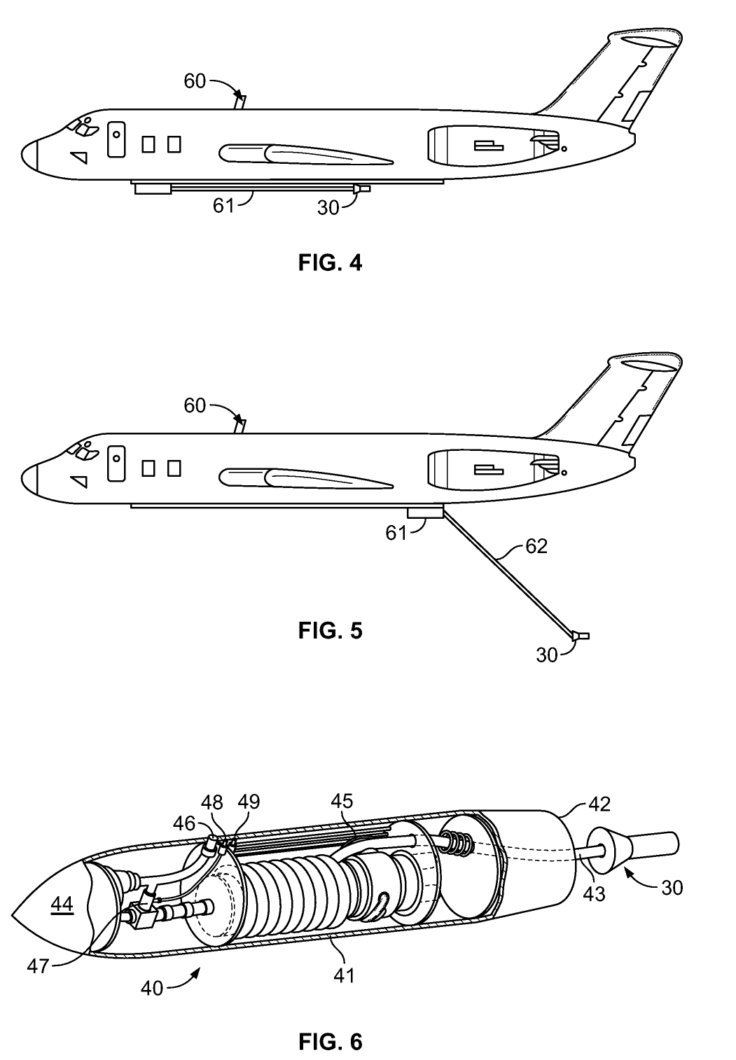

Various systems have been patented for air to air refueling of aircraft and such technology can be employed as part of the novel protection system of this invention where the decoy is deployed on a tether such as shown in FIGS. 2 and 3 or by use of a boom as shown FIGS. 4 and 5.

For example the pod shown in FIG. 6, is adapted from an air to air refueling pod 40. This pod includes a hollow bullet shaped case 41 with mounting fixtures (not shown) and a large opening 42 in the rear of the pod. This cylindrical opening receives the decoy 30 as its docket station, when the hose 43 in the pod is reeled in, and deploys the decoy, as the hose is paid out from the pod, the hose serving as a tether for the decoy. This hose or tether include the ignition cable for the decoy and controls in the pod can meter the jet fuel to the decoy.

Referring back to FIG. 6, the pod 40 shown, has a compact reel system, which is more than adequate for storing enough length of hose 43 to fly the decoy sufficiently aft of the aircraft to place the decoy in a location that a missile striking it will not be in sufficient proximity to the aircraft to damage the aircraft (that is the decoy is outside the kill radius of the missile). A driving mechanism such a reversible electric motor with reduction gearing (not shown) is mounted in the nose cone 44 of the pod to rotate the reel on which hose 43 is wound and carrier wheel 45 cycling along side of the reel to lay the hose on the reel, as shown. A fuel inlet 46 is supplied to the pod which is in communication with the aircraft's fuel supply and connects to valve 47 that is controlled through electrical cable 48 plugged in to aircraft's control system. The electric motor in the nose cone is controlled by electrical cable 49. Simply put it is well known in the prior art to supply jet fuel from an aircraft though a hose or tether for the purposes of air to air refueling, which technology is adapted to the instant invention.

Referring to FIGS. 2 and 3, the decoy 30 is shown deployed from such a pod, in the case of the large aircraft 50 in FIG. 2 from a pod 40 mounted on pylons 51 on the sides of the aircraft's fuselage and on the aircraft 55, in FIG. 3, from a rear portion of the aircraft through hose 43.

Also the decoy can be deployed on a telescoping probe extended from the belly of a jet aircraft, shown in FIGS. 4 and 5, which illustrate a jet aircraft 60 has a boom system 61 deployed on its belly in the retracted position in FIG. 4 and in the extended position in FIG. 5. Boom 62 is deployed from the belly of the aircraft and the decoy 30 is connected to the end of the boom as shown. Jet fuel from the aircraft is supplied to the boom and thence to the decoy where it is burned to produce the desired IR and UV signature typical of the engines of jet aircraft.

Other configurations for the creating the high thermal signature in a decoy can be used which are based on burning jet fuel through the torching of jet fuel from the aircraft in the decoy, since a blow torch burner can easily reach 1500 degrees F. Since the decoy uses jet fuel from the aircraft it can be operated for extended periods without danger to the aircraft or structures on the ground. Moreover, the use of jet fuel allows the creation of a high intensity IR signature.

A typically commercial jet aircraft will have a length: 155 feet 3 inches (47.32 meters) and a wingspan: 124 feet 10 inches (38.05 meters). Since a boom needs to position the decoy only approximately 16 meters behind or remote from the aircraft so the aircraft will be outside the kill radius of a shoulder filed missile, the boom can be mounted on the underside of the aircraft. Moreover, if the pod 40 is mounted on the wing tip, the pod will be at least 20 feet off the ground allowing the decoy 30 to be suspended from the pod a distance of 15 feet or so. As a result the use of the protective system can be used during take offs and landing without difficulty when employing such a short tether, even with an actuated rotation of the aircraft on take off; of course the boom mounted system is not deployed until after the aircraft is airborne in most cases due to the rotation that occurs during take off Moreover the air slip stream at take off speed of the aircraft is sufficient to initiate the operation of the decoy.

It should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

Having described by invention, I claim:

1. An anti-missile decoy for jet aircraft comprising:
a tether means having a first end and a second end, said first connected to an aircraft to be protected and said tether including a fluid conduit integrated therein;
a source of jet fuel connected from such aircraft to said fluid conduit; and
a decoy means connected to said second end of said tether means and having in fluid communication with said conduit, said decoy means having a ignition means operable to ignite jet fuel received from said conduit in said decoy means to create a significant thermal signature in said decoy means from the combustion of the jet fuel therein whereby shoulder fired missiles will be diverted from the IR signatures of said aircraft to said decoy means.

2. The anti-missile decoy of claim 1 wherein the decoy means is a pulse jet engine means.

3. The method of protecting an aircraft during flight from shoulder fired missiles by burning jet fuel from the aircraft in a torching means to create a high intensity IR signature in said torching means at location sufficiently remote from said aircraft that the aircraft will be outside the burst radius of most such missiles when such missiles strike said torching means whereby said aircraft is unlikely to be damaged such missiles.

4. The method of protecting jet aircraft defined in claim 3 wherein the torching means creates IR and UV signatures nearly identical to those of the aircraft's jet engines.

5. The method of protecting jet aircraft defined in claim 3 wherein the torching means is a pulse jet engine with its combustion chamber unshielded.

6. The method of protecting jet aircraft defined in claim 3 wherein the torching means creates exhaust plume nearly which is nearly identical to spectra of the exhaust plumes of the aircraft's jet engines.

6. A method of protecting jet aircraft from shoulder fired missiles comprising the steps of:
towing a decoy means from the aircraft at a distance whereby said decoy means is located at least eight meters away from any part of said aircraft;
supplying said decoy means with jet fuel from said aircraft; and
burning said jet fuel in said decoy means to create a high intensity IR signature in the decoy means sufficient to divert shoulder fired missiles from said aircraft to said decoy means while said aircraft is flying where it can be hit with shoulder fired missile.
